(19) United States
(12) Patent Application Publication
(10) Pub. No.: US 2014/0057730 A1
(43) Pub. Date: Feb. 27, 2014

(54) CONNECTING JOINT FOR A CONNECTING SHAFT AND CONNECTING SHAFT WITH SUCH A CONNECTING JOINT

(71) Applicants: Ruben Steinhauser, Altusried (DE); Markus Wintergerst, Hawangen (DE); Bernd Wintergerst, Hawangen (DE)

(72) Inventors: Ruben Steinhauser, Altusried (DE); Markus Wintergerst, Hawangen (DE); Bernd Wintergerst, Hawangen (DE)

(21) Appl. No.: 13/968,870

(22) Filed: Aug. 16, 2013

(30) Foreign Application Priority Data
Aug. 24, 2012 (DE) 10 2012 215 108.7

(51) Int. Cl. F16D 3/79

(52) U.S. Cl. CPC F16D 3/79
USPC 464/98

(57) ABSTRACT

A connecting joint for connecting two shafts comprises a drive seat and an output seat, wherein the drive seat and the output seat are connected by a connecting means with one another, which may be provided in an angular way. Therein, the connecting means comprises an element which is at least partially flexible. One or multiple, in particular two, such connecting joints may be used in a connecting shaft for transmitting a rotation from a drive shaft to an output shaft, in particular in a connecting shaft of a drum for a drum set.

### CROSS-REFERENCE TO RELATED APPLICATIONS

The present application is related to, and claims the benefit of priority from, German Patent Application No. 10 2012 215 108.7, filed Aug. 24, 2012, the disclosure of which is incorporated herein by reference in its entirety.

### FIELD OF THE INVENTION

The invention relates to a connecting joint for a connecting shaft as well as to a connecting shaft with such a connecting joint, in particular a connecting shaft for a foot-driven drum of a drum set.

### BACKGROUND

In the field of drum sets, in order to keep the possible playing variations as big as possible, it is common to use multiple foot-driven drums, so called base drums. Thus, the drummer may use both feet in order to play more complex rhythmic figures. The logistic effort to transport a second base drum and to integrate it in a drum set, however, conflicts with the additional benefit.

Therefore, a known double-pedal was developed, which allots two beaters that hit onto the same base drum. Therein, however, the two pedals need to be arranged to be individually adjustable, spaced from one another and in an angled position to one another which is convenient to the player. Therefore, the second, additional pedal, also denoted as slave pedal, is connected with the axis of the main pedal by means of a cardan shaft, where the two beater units are provided.

However, it is a problem therein that the known cardan shaft used for the connection of the slave pedal with the second beater for technical reasons does not reliably transmit the force linearly. Rather, due to signs of wear after a certain time the moveable parts of the joints start to knock out. In order to delay such wear, high quality materials and bearings have to be used.

Even for unworn components, by using the common cross joints with the shaft, the transmission of the torque in an angled arrangement of the joints is not effected steadily. This so called gimbal error causes a leading or lagging of the rotation angle in the form of sinusoidal-like variations of the second shaft, wherein the unconformity increases with increasing deviation angle of the shaft.

This error may be compensated with a second cross joint, this, however, requires further components. In addition, a respective arrangement of the slave pedal had to be considered. This may confine the player. If such an arrangement is desisted, for the common pedals this leads to the transmission of the angular velocity of the slave pedal not being the same as the one of the main pedal also referred to as master pedal. These differences may be detected audibly and thus are undesired.

It is therefore an object of the invention to provide a connecting joint or a connecting shaft in order to circumvent at least one of the above mentioned disadvantages.

### SUMMARY OF THE DISCLOSURE

This object is solved by a connecting joint according to claim 1 as well as by a connecting shaft according to claim 9. This connecting shaft may, according to claim 12, be used for force transmission in order to drive a drum beater. Advantageous developments of the invention are subject of the dependent claims.

A connecting joint according to the invention serves for the connection of two shafts and comprises a drive seat as well as an output seat. The drive seat and the output seat are connected with one another by means of a connecting means, which may be provided angularly, i.e., which is designed such that the drive seat and the output seat may be arranged in an angle with respect to one another. The connecting means further comprises at least one plate, which at least partially is flexible. Preferably, this plate is arranged between the drive seat and the output seat.

The drive seat therein serves for receiving a drive element or a shaft being coupled with a drive element. The output element, analogously, serves for receiving an output element or a shaft coupled with an output element.

While in the preferred embodiment the connecting means comprises the flexible plate, the connecting means, however, may in general merely comprise one element being at least partially flexible, which may also be provided at the drive seat or at the output seat.

Such a connecting joint allows a tight connection of two shafts without the torque transmission being subjected to a gimbal error. Further, such a connecting joint enables a uniform transmission independent of the deviation angle.

The flexible plate in particular may be a membrane plate, formed as a steel disk, preferably as a spring steel disk. In the meaning of the invention, such plates are denoted as membrane plate, which have a thickness much smaller than their remaining dimensions.

In one development of the invention, the drive seat and/or the output seat may comprise a fastening means, which is tightly connected with the connecting means. The connection therein is effected at at least one point, preferably, however, at two points, in particular at two points of the connecting means being arranged diametrically opposing one another. In the preferred embodiment, the fastening means is screwed to two points of a spring steel disk diametrically opposing one another. Therein both the fastening means and the steel disk comprise corresponding congruent, i.e. brought to coverage on top of one another, borings for fastening. Alternatively, the fastening means may be connected with the connecting means in a different way, for instance by soldering, welding, riveting, gluing or such. Due to this tight connection, the number of the moveable parts is reduced, preferably even eliminated, such that signs of wear may be reduced. This may increase reliability.

Further, for this kind of connection, higher manufacturing tolerances may be granted, since the support parts, that are the drive seat and the output seat or their connecting sleeves may be connected tightly, in particular by means of machine screwing. This may allow an easier manufacturing.

The respective fastening means, i.e., the connecting sleeves, of the drive seat or of the output seat may therein be connected with the connecting means such that they are angled, in particular perpendicular with respect to each other. Therein, the drive or output seat is mounted onto opposing sides of the connecting means. That means that the fastening means of the drive seat is arranged along a planar plane defining the connecting means, in particular on the surface of the plate, while the fastening means of the output means is parallel to this plane on the other side of the connecting means. The flexible element in the connecting means is built such that the drive seat and the output seat are angularly adjustable relative to one another.

Thus, an angular arrangement of a driving shaft with respect to an output shaft is possible, being connected with the connecting means. Due to such a tilting, the connecting means, in particular the steel disk, would experience a deformation, preferably an elastic deformation. In the preferred embodiment, the drive seat is mounted at two points, which are situated diametrically opposed on a line in the fastening plane running through the centre point of the plate, while the fastening points of the output seat are on a line perpendicular to the above mentioned line, also running through the centre point of the plate, being diametrically arranged in the fastening plane. The hypothetical connecting line between the fastening points of the preferred embodiment therein is an axis, around which the respective seat is tiltable. An angular arrangement of the drive and output seat thus is to be comprehended such that the tilt axis of the drive seat differs from the tilt axis of the output seat.

In the preferred embodiment, the connecting means further may comprise two such plates, which are connected to one another by means of a connecting piece. This may increase the flexibility of the connecting means. In a case that two plates are used, the fastening means of the drive and output seat are arranged at least angularly with respect to the connecting piece between the plates, in particular perpendicularly, wherein the drive and output seats may be arranged coaxially with respect to one another.

If the drive seat and the output seat do receive a drive shaft or an output shaft, respectively, the drive shaft may be tiltable around the fastening points of the drive seat at the connecting means and the output shaft may be tiltable around the fastening points of the output seat. In particular, it is preferred that the drive seat and the output seat are tiltable in different, at least opposing, directions, with respect to one another.

Then the drive seat preferably is connected with one plate, while the output seat is connected with the respective other plate.

In all embodiments described above it is possible that a drive shaft, being received in the drive unit, and an output shaft, being received in the output unit, may be angularly arranged with respect to one another. This may be effected by respective adjustment of the connecting means in the connecting joint.

A connecting shaft according to the invention to transmit a rotation from a drive shaft to an output shaft comprises a connecting joint according to the above descriptions. Such a connecting joint preferably is provided at each end of the connecting shaft. That way, the connecting shaft virtually may be arranged in an arbitrary angle, which allows a maximum degree of freedom for the arrangement of the drive or the output shaft. The connecting shaft therein may be provided in multiple pieces, in particular with one or more shaft portions, which may be received by the drive seat or the output seat of the membrane joint. The shaft portions thus preferably are provided at outer end portions of the connecting shaft.

The shaft may further comprise a shaft mid portion, which is connectable with the shaft portions such that the connecting shaft may be adapted to a plurality of different drive or output seats. For this only the connecting shaft portions have to be modified. This can allow manifold use of the connecting shaft.

Such a connecting shaft may in particular be used for transmitting a drive force of a drive unit, which is formed as a foot pedal of a drum set, to an output shaft, which is connected with a drum beater. The output force transmitted by means of the connecting shaft therein may drive the drum beater. The foot pedal therein is coupled with the drive shaft, while the drum beater is coupled with the output shaft.

Thus, an optimal transmission of power may be achieved without loss of force for instance due to friction of moveable parts or due to appearance of gimbal errors, which may result in a better playability of such a drum set. This may allow a better playing sensation to the player, due to a possible linear force transmission.

### BRIEF DESCRIPTION OF THE DRAWINGS

Details, further advantages and developments of the invention will be described in more detail with the help of an embodiment and reference to the figures. Therein shows:

FIG. 1 a connecting shaft according to the invention with a connecting joint according to a preferred embodiment,

FIG. 2 a magnified view of the connecting joint according to the preferred embodiment,

FIG. 3 a partial exploded view of a portion of the connecting joint according to the preferred embodiment.

### WRITTEN DESCRIPTION

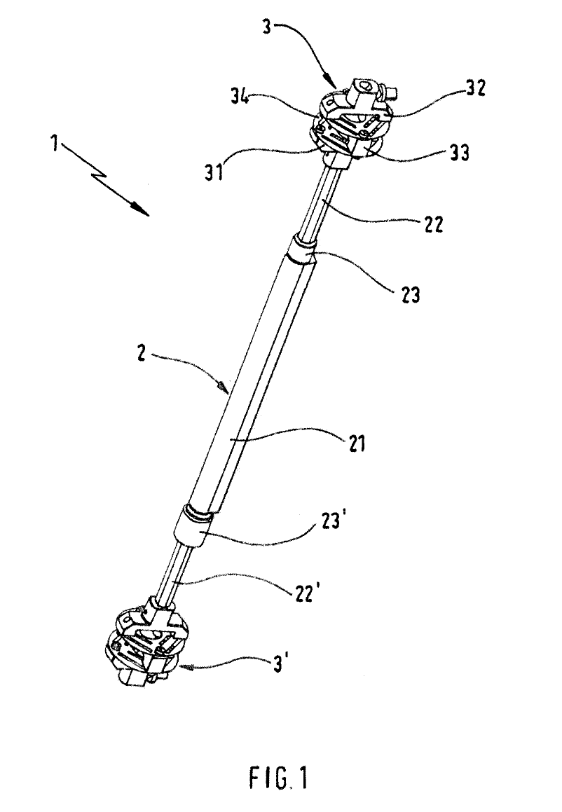

FIG. 1 shows a connecting shaft 1 according to the invention according to a preferred embodiment. The connecting shaft 1 comprises a shaft portion 2 and two connecting joints 3, 3′. The shaft portion 2 consists of a shaft mid piece 21 and two shaft end pieces 22, 22′. The shaft end pieces 22, 22′ are connected with the shaft mid piece 21 by means of shaft adapters 23 and 23′, respectively.

The shaft adapters 23, 23′ are formed such that on one side facing the shaft end piece 22, 22′ they comprise receiving openings for the respective shaft end piece 22, 22′. On the side facing the shaft mid piece 21, they may receive the shaft mid piece 21. Depending on the shaft end pieces used, the size of the shaft adapters 23, 23′ may be adapted to the individual necessities.

In the shown embodiment, the shaft end pieces 22, 22′ are formed in analogy to one another. The same is true for the connecting joints 3, 3′ as described in the following. Therefore, the descriptions, which are made for one side, are effective analogously also for the respective other side, as far as this is not described differently in the special case.

The connecting joint 3 is connected with a shaft end piece 22 of the connecting shaft 1. Since the connecting shaft 1 is used for force transmission from a drive source to an output shaft, the following definitions apply for a simplified description. Those components, which are closer to the driving side are denoted with the prefix “drive . . . ”, while those components, which are closer to the outputting side are denoted with the prefix “output . . . ”. Due to the symmetric structure of the connecting shaft 1 in the preferred embodiment, the reference signs are comprehendible on their own terms and, in particular, of course, also apply, if the connecting shaft is integrated in a system reversely, against the denominations used herein.

It is also possible that the connecting shaft 1 is not symmetrically formed, but, for instance, comprises connecting joints of different kind, as they will still be described.

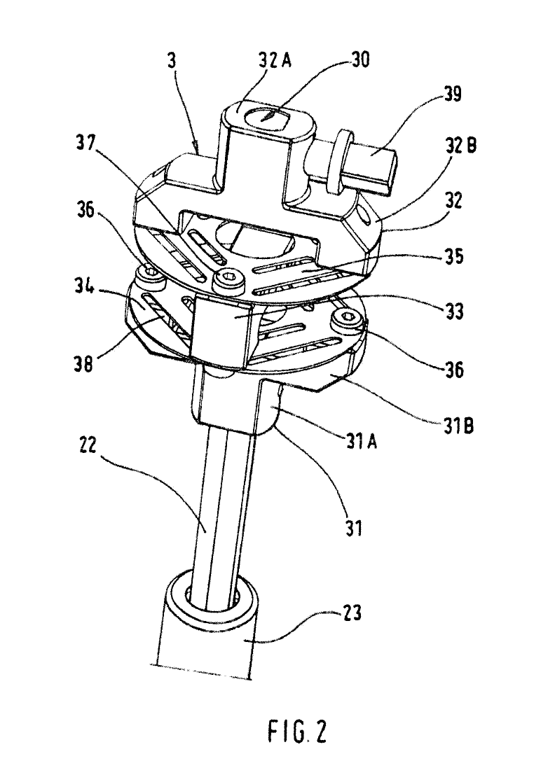

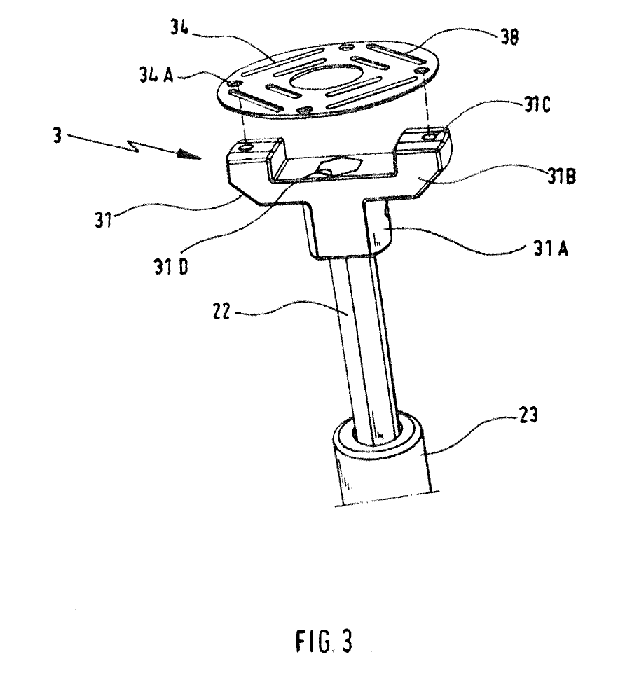

The connecting joint 3 according to the preferred embodiment is illustrated in a magnified way in FIG. 2. On a side facing the shaft portion 2, the connecting joint 3 comprises a drive seat 31. The drive seat 31 is formed such that it may receive the shaft end piece 22. For this, the drive seat 31 has a protrusion 31A with a recession or a bore hole 31D there trough (compare FIG. 3). That way, the shaft end piece 22 is received in the protrusion 31A and connected with the drive seat 31. The drive seat 31 may in different embodiments also be formed as one piece with the shaft end piece 22, which may allow a better force transmission and an easier assembly.

At a side of the drive seat 31 facing away from the shaft end piece 22, the drive seat 31 comprises a U-shaped connection portion 31B, as can be seen in particular from FIG. 3. The legs of the connection portion 31B therein are symmetrical and formed having the same length. On the end portions of the U-legs at the face side, the threaded holes 31C are provided. The threaded holes 31C serve for receiving of fastening screws, as will be described later.

Adjacent to the drive seat 31, a first plate 34, also denoted as membrane plate and preferably formed as spring steel plate, is provided. The plate 34 is arranged in contact with the drive seat 31. Therein, the plate 34 is formed with through holes 34A for receiving a fastening means, here fastening screws 36. The plate 34 in the preferred embodiment is formed circularly. The circumference of the plate 34 therein corresponds to the maximum width of the U-shaped portion of the drive seat 31. The plate 34 and the drive seat 31 in particular are formed such that in the peripheral contact region in circumferential direction they abut to one another form-fittingly. The through holes in the plate 34 are provided diametrically, such that they may coincide with the threaded holes in the drive seat 31.

It is also possible that the legs of the connection portion 31B have different lengths. This may then account for an angular arrangement of the plate 34 without having to exert a force to the plate 34 or the joint 3. It is also possible that the plate itself is tapered, i.e. does not have the same thickness continuously.

The rotation axes of the shaft portion 2 and the drive seat 31 here are provided on a line, in order to prevent an eccentric movement. The centre of the plate 34 further is provided on a line with the extension direction of the protrusion 31A of the drive seat 31.

The plate 34 further has a second pair of holes, which are arranged on a line, which is perpendicular to a hypothetical connection line of the above mentioned holes and is running through the centre of the plate 34, as well. Further, the plate 34 in the preferred embodiment comprises a plurality of slits 38. These slits 38 increase the flexibility of the plate 34 and may be provided in multiple ways. At present, the slits are formed in a direction perpendicular to a radial direction, starting from the centre of the plate. Those slits, which are situated more remote from the centre when seen in a radial direction, at present are formed longer than slits close to the centre.

Of course, it is also possible that the plate 34 has a different shape, for example a hexagonal shape or other, symmetrical or unsymmetrical shapes, as long as the connection between the components remains possible in the way as described above.

In the preferred embodiment, the connecting joint 3 is connected with a further plate 35 by means of a connecting piece 33, as can be seen in FIG. 2. The plate 35 preferably is formed identically to the first plate 34 such that a detailed description with respect to its design or its position is omitted here. However, depending on the intended use, it is possible that the slits 38, which are provided in both plates, may differ from one another in their shape, their orientation or their length. That way, for example, an elastic force of the individual plates 34, 35 may be varied in a preferred direction.

The connection piece 33, connecting the two plates 34, 35, is formed as a double-T-type (not shown) and provided such that the T-shaped protrusions each coincide with a hole of the first plate 34 and a hole of the further plate 35, respectively. For this the protrusions further comprise threaded holes, at which the plates 34, 35 may be fastened, for instance by means of screws 36. Corresponding to the position of the holes, the connecting piece 33 therein is oriented perpendicular to the general arrangement direction of the drive seat 31, i.e., the connection line of its fastening points. The orientation may, however, electively be in an arbitrary angle, as long as the fastening holes are also provided in the plates 34, 35 such that a tight connection with the connecting piece 33 is possible.

On a side facing away from the drive seat 31 of the plate 35, an output seat 32 is arranged, as can be seen in FIG. 2. The output seat 32 is formed analogously to the drive seat 31, such that a description may essentially be omitted. In the preferred embodiment, a connection portion 32B of the output seat 32 also comprises U-shaped legs. These are facing the plate 35 and are tightly connected with the plate 35 by means of a fastening means, here screws (not shown).

At a protrusion 32A of the output seat a fixing means 39 is provided in addition to a receiving bore 30. The fixing means 39 protrudes in a direction perpendicular to the extension direction of the protrusion 32A, parallel to the extension direction of the connection portion 32B. The fixing means 39 therein essentially consists of an engaging means, which extends into the protrusion 32A and which, by way of manipulation, for example screwing, may be inserted into the protrusion. That way, elements which are inserted into the protrusion 32A, for instance an end portion of an output shaft (not shown), may be fastened in the protrusion 32A.

While in the preferred embodiment the drive seat 31 and the output seat 32 are oriented in parallel to one another, that means their connection portions 31B and 32B, respectively, extend in parallel to one another, it is also possible that the drive seat 31 and the output seat 32 are mounted and fastened in a twisted way with respect to one another in the plane of the respective plate 34, 35, i.e. they are angled with respect to one another. For this, only the holes in the plates 34, 35 have to be provided in different positions.

Further, it is possible that the connecting joint does not comprise multiple, in particular two, plates, as was shown, but merely one plate. Drive seat and output seat may be fastened on the same plate. This, in particular, is possible in those cases in which the connecting shaft only needs to be aligned for small angles. Especially in this case, but also in cases with multiple plates, it is also possible that the drive seat and/or the output seat merely is connected at one point of the plate.

Conclusively, a connecting joint 3 for connection of two shafts comprises a drive seat 31 and an output seat 32, wherein the drive seat 31 and the output seat 32 are connected with one another by means of a connecting means 33, 34, 35, which may be provided angularly. Therein, the connecting means 33, 34, 35 comprises an element 34, 35 which is at least partially flexible. One or multiple, in particular two, such connecting joints may be used in a connecting shaft for transmission of a rotation from a drive shaft to an output shaft, in particular in a connecting shaft for a drum of a drum set.

### LIST OF REFERENCE SIGNS

1 connecting shaft
2 shaft portion
3 joint portion
21 shaft mid piece
22 shaft end piece
23 shaft adapter
30 connection portion
31 drive seat
31A protrusion
31B connection portion
31C threaded holes
32 output seat
32A protrusion
32B connection portion
33 connecting piece
34 membrane plate
35 membrane plate
36 screw
37 screw
38 plate slit
39 fixing means

1. A connecting joint for connection of two shafts, comprising a drive seat and an output seat, wherein the drive seat and the output seat are connected with each other via a connecting means providable in an angled way, characterized in that the connecting means comprises an element, which is at least partially flexible.

2. The connecting joint according to claim 1, characterized in that the flexible element is a flexible plate, in particular a membrane plate.

3. The connecting joint according to claim 2, characterized in that the flexible plate is a steel plate, in particular a spring steel plate.

4. The connecting joint according to claim 1, characterized in that the drive seat and/or the output seat comprises a fastening means, which is tightly connected with the connecting means at at least one point, preferably at two points being diametrically opposed.

5. The connecting joint according to claim 4, characterized in that the fastening means of the drive seat is connected with the connecting means angularly, in particular perpendicular, with respect to the fastening means of the output seat.

6. The connecting joint according to claim 4, characterized in that the fastening means of the drive seat is connected with the connecting means in parallel to the fastening means of the output seat.

7. The connecting joint according to claim 1, characterized in that the connecting means comprises at least two plates, which are connected with each other by means of a connecting piece.

8. The connecting joint according to claim 7, characterized in that the drive seat is connected with a plate and the output seat is connected with a further plate.

9. A connecting shaft for transmitting a rotation of a drive shaft to an output shaft, characterized in that the connecting shaft comprises at least one connecting joint for connection of two shafts, each at least one connecting joint comprising a drive seat and an output seat, wherein the drive seat and the output seat are connected with each other via a connecting means providable in an angled way, characterized in that the connecting means comprises an element, which is at least partially flexible.

10. The connecting shaft according to claim 9, characterized in that the connecting shaft comprises a shaft portion, which is receivable by the drive seat or the output seat of the connecting joint, as the case may be.

11. The connecting shaft according to claim 9, characterized in that the shaft portion is connectable with a shaft mid portion.

12. A foot pedal assembly for a drum, the foot pedal assembly comprising a drum beater coupled to an output shaft, a connecting shaft for transmitting a rotation of a drive shaft to the output shaft, and a foot pedal for creating a force to be transmitted by the connecting shaft, and wherein the connecting shaft comprises at least one connecting joint for connection of two shafts, each at least one connecting joint comprising a drive seat and an output seat, wherein the drive seat and the output seat are connected with each other via a connecting means providable in an angled way, characterized in that the connecting means comprises an element, which is at least partially flexible.
